(19) United States
(12) Patent Application Publication
(10) Pub. No.: US 2006/0230151 A1
(43) Pub. Date: Oct. 12, 2006

(54) Multi-mode terminal for supporting media independent handover

(75) Inventors: Yong Ho Kim, Bucheon-si (KR); Yong Won Kwak, Anyang-si (KR); Jin Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/400,084

(22) Filed: Apr. 6, 2006

(30) Foreign Application Priority Data
Apr. 9, 2005 (KR) 2005-0029749

(51) Int. Cl. G06F 15/173

(52) U.S. Cl. 709/226

(57) ABSTRACT

The present invention relates to a mobile terminal for performing a handover to at least one of a homogeneous and heterogeneous network. Accordingly, media independent handover (MIH) is supported, by which a delay attributed to the occurrence of processing during handover between heterogeneous media-independent networks is reduced. Preferably, the present invention comprises at least one network interface module supporting a predetermined air interface, a heterogeneous network handover module configured to provide convergence of information from the at least one network interface module associated with the at least one of a homogeneous and heterogeneous network into a unified presentation, and a management module configured to process the unified presentation communicated with the heterogeneous network handover module to communicate with the at least one network interface module to facilitate handover.

### CROSS-REFERENCE TO RELATED APPLICATIONS

Pursuant to 35 U.S.C. § 119(a), this application claims the benefit of earlier filing date and right of priority to Korean Application No. 2005-0029749, filed on Apr. 9, 2005, the contents of which is hereby incorporated by reference herein in its entirety.

### FIELD OF THE INVENTION

The present invention relates to a broadband wireless access system, and more particularly, to a mobile terminal for performing media independent handover to at least one of a homogeneous and heterogeneous network in a broadband wireless access system.

### BACKGROUND OF THE INVENTION

FIGS. 1 to 3 are diagrams of protocol stack architectures for an IEEE 802.16 interface, an IEEE 802.11 interface and a 3GPP interface, respectively.

IEEE 802.21 aims for the international standardization of inter-heterogeneous-network media independent handover. Specifically, IEEE 802.21 endeavors to enhance user convenience when operating mobile terminal devices by providing seamless handover and service continuity between heterogeneous networks. A media independent handover (MIH) function, an event trigger, a command service and an information service (IS) are defined as basic requirements in the IEEE 802.21 standard specification, which is incorporated herein by reference.

A mobile subscriber station is a multi-node that supports at least one interface type. An interface can include a wire-line type interface such as an IEEE 802.3-based Ethernet, wireless interface types based on IEEE 802.XX interfaces including IEEE 802.11, IEEE 802.15, IEEE 802.16 or the like, and interfaces defined by a cellular standardization organization such as 3GPP and 3GPP2 and the like.

Media independent handover (MIH) may be defined between IEEE 802-series interfaces or between an IEEE 802-series interface and a non-IEEE 802-series interface, such as 3GPP or 3GPP2. Furthermore, a mobility supporting protocol of an upper layer such as a mobile Internet protocol (Mobile IP) and a session initiation protocol (SIP) should be supported for the seamless handover service.

FIG. 4 is a diagram of a general MIH reference model for supporting an MIH function.

Service access points (SAPs) for considering the MIH function are explained as follows. An MIH function layer-management plane service access point (MIH_MGMT_SAP) defines an interface between an MIH function layer and a management plane. MIH messages can be used for communications between peer MIH entities. MIH messages based on a management frame can be also sent unauthorized. The MIH_MGMT_SAP also defines primitives used for Media Independent Event Services, Media Independent Command Services and Media Independent Information Services.

An MIH function layer-station management entity service access point (MIH_SME_SAP) defines an interface between an MIH function layer and a station management entity (SME) defined by IEEE 802.11 or a network control and management system (NCMS) defined by IEEE 802.16. The MIH_SME_SAP can be identical to the MIH_MGMT_SAP.

An MIH function layer-user service access point (MIH_USER_SAP) defines an interface for communication with an upper layer or higher (IP layer, i.e., at least protocol layer 3 or higher).

An MIH function layer-medium access control layer service access point (MIH_MAC_SAP) defines an interface between an MIH and a medium access control (MAC) layer of each technology (IEEE 802.11, IEEE 802.16, 3G, etc.). Interfaces defined by the MIH_MAC_SAP are mainly used in transferring MAC service data units (MSDUs) between peer entities. It is unnecessary to define a new interface and primitive for the MIH_MAC_SAP. However, interfaces defined through the MIH_MAC_SAP can be used in delivering payloads based on an MIH protocol to peer MIH entities.

An MIH function layer-physical layer service access point (MIH_PHY_SAP) defines an interface between an MIH and a physical (PHY) layer of each technology (IEEE 802.11, IEEE 802.16, 3G, etc.). The MIH communicates through the PHY of a corresponding technology using MACs of the corresponding technology. It is unnecessary to define new interfaces and primitives for the MIH_PHY_SAP.

An LSAP defines an interface between an MIH and a lower link control (LLC) layer. The MIH initiates a connection to a peer LLC entity to perform communication. The LSAP can directly use an LLC interface to establish a data path for sending MSDUs through other links. It is unnecessary to define new interfaces and primitives for the LSAP.

An MIH function layer-radio resource control layer service access point (MIH_RRC_SAP) defines an interface between an MIH function and a radio resource control (RRC) layer.

The MIH function is placed below an IP layer and facilitates a handover handling process using a trigger event and an input value, such as information of other networks and the like, from a second layer (Layer 2) entity. The MIH function can include input values based on user policy and configuration that can influence the handover process. General interfaces are defined between the MIH function and a third layer (Layer 3) entity, such as the Mobile IP and SIP. These interfaces provide information about a first layer (Layer 1) (PHY layer), the second layer (Layer 2) (MAC layer) and mobility management. The MIH acquires information about lower layers and networks with the help of the event and information services.

Hence, the MIH function should be placed in a higher layer to monitor and control statuses of other links within the mobile subscriber station. FIG. 5 is a diagram of functional entities and transport protocols of a terminal including an MIH function and a network. Dotted lines indicate a primitive, an event trigger and the like.

FIG. 6 is diagram of a configuration of an IEEE 802.16 system in a protocol stack considering MIH. This model can be identically applied to a base station and a mobile subscriber station. However, because a multi-mode mobile subscriber station and a multi-stack mobile subscriber station should be taken into consideration, a mobile subscriber station should include the configuration shown in FIG. 6.

FIG. 7 is diagram of a configuration of an IEEE 802.11 system in a protocol stack considering MIH. This model can be identically applied to a base station and a mobile subscriber station. However, because a multi-stack mobile subscriber station of multi-mode should be taken into consideration, a mobile subscriber station should include the configuration shown in FIG. 7.

FIG. 8 is diagram of a configuration of a 3GPP system in a protocol stack considering MIH. This model can be identically applied to a base station and a mobile subscriber station. However, because a multi-stack mobile subscriber station of multi-mode should be taken into consideration, a mobile subscriber station should include the configuration shown in FIG. 8.

In the related art, the MIH layer is placed below the IP layer and above the MAC layer in common to support media independent handover. Notably, only the architectures of the MAC and lower layers are clearly defined, whereas the architectures of IP and higher layers are not clearly defined. Accordingly, a multi-mode terminal has difficulty using a unified system. Moreover, it is difficult to define operations of the MIH.

### SUMMARY OF THE INVENTION

The present invention is directed to a mobile terminal for supporting media independent handover.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a mobile terminal for performing a handover to at least one of a homogeneous and heterogeneous network, the mobile terminal comprising at least one network interface module supporting a predetermined air interface, a heterogeneous network handover module configured to provide convergence of information from the at least one network interface module associated with the at least one of a homogeneous and heterogeneous network into a unified presentation, and a management module configured to process the unified presentation communicated with the heterogeneous network handover module to communicate with the at least one network interface module to facilitate handover.

In one aspect of the present invention, the heterogeneous network handover module comprises at least one media independent handover entity corresponding to the at least one network interface module. In another aspect of the invention, the heterogeneous network handover module comprises a heterogeneous network handover submodule configured to provide convergence of information and at least one media independent handover entity corresponding to the at least one network interface module. In a further aspect of the invention, the heterogeneous network handover module comprises a first heterogeneous network handover module configured to communicate with the management module and a second heterogeneous network handover module configured to communicate between the first heterogeneous network handover module and the at least one network interface module.

In one aspect of the present invention, the at least one network interface module comprises one of a wired-line broadband interface, a wireless broadband interface and a cellular interface. Preferably, the broadband interface comprises at least one of a wireless local area network and a wireless metropolitan area network. Preferably, the cellular interface comprises at least one of a WCDMA and a cdma2000.

In another aspect of the present invention, the management module comprises at least one of a device manager, a mobility management protocol, an Internet protocol module, a transmission control protocol module and a user datagram protocol module. In a further aspect of the present invention, the unified presentation of the heterogeneous network handover module is communicated to the management module through a service access point.

In one aspect of the present invention, the heterogeneous network handover module communicates with the at least one network interface module through a management service access point and a control service access point. In another aspect of the invention, the heterogeneous network handover module communicates with the at least one network interface module through one of a MAC sublayer management entity and a physical layer management entity.

In accordance with another embodiment of the present invention, a method for performing handover to at least one of a homogeneous and heterogeneous network comprises supporting a predetermined air interface with at least one network interface module, providing a heterogeneous network handover module for converging information from the at least one network interface module associated with the at least one of a homogeneous and heterogeneous network into a unified presentation and providing a management module for processing the unified presentation communicated with the heterogeneous network handover module to communicate with the at least one network interface module to facilitate handover.

In one aspect of the present invention, the heterogeneous network handover module comprises at least one media independent handover entity corresponding to the at least one network interface module. In another aspect of the invention, the heterogeneous network handover module comprises a heterogeneous network handover submodule configured to provide convergence of information and at least one media independent handover entity corresponding to the at least one network interface module. In a further aspect of the invention, the heterogeneous network handover module comprises a first heterogeneous network handover module configured to communicate with the management module and a second heterogeneous network handover module configured to communicate between the first heterogeneous network handover module and the at least one network interface module.

In one aspect of the present invention, the at least one network interface module comprises one of a wired-line broadband interface, a wireless broadband interface and a cellular interface. Preferably, the broadband interface comprises at least one of a wireless local area network and a wireless metropolitan area network. Preferably, the cellular interface comprises at least one of a WCDMA and a cdma2000.

In another aspect of the present invention, the management module comprises at least one of a device manager, a mobility management protocol, an Internet protocol module, a transmission control protocol module and a user datagram protocol module. In a further aspect of the present invention, the unified presentation of the heterogeneous network handover module is communicated to the management module through a service access point.

In one aspect of the present invention, the heterogeneous network handover module communicates with the at least one network interface module through a management service access point and a control service access point. In another aspect of the invention, the heterogeneous network handover module communicates with the at least one network interface module through one of a MAC sublayer management entity and a physical layer management entity.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIGS. 1 to 3 are diagrams of protocol stack architectures of an IEEE 802.16 interface, an IEEE 802.11 interface and a 3GPP interface, respectively.

FIG. 4 is a diagram of a general MIH reference model for supporting an MIH function in a mobile terminal.

FIG. 5 is a diagram of functional entities and transport protocols of a terminal including an MIH function and a network.

FIG. 6 is diagram of a configuration of an IEEE 802.16 interface in a protocol stack considering MIH.

FIG. 7 is diagram of a configuration of an IEEE 802.11 interface in a protocol stack considering MIH.

FIG. 8 is diagram of a configuration of a 3GPP system in a protocol stack considering MIH.

FIG. 9 illustrates an architecture for implementing a protocol stack in a multi-mode terminal, wherein an MIH CS is not included in accordance with one embodiment of the present invention.

FIG. 10 illustrates an architecture for implementing a protocol stack in a multi-mode terminal, wherein an MIH CS is included in accordance with one embodiment of the present invention.

FIG. 11 illustrates an architecture for implementing a protocol stack in a multi-mode terminal, wherein an upper MIH CS and a lower MIH CS are included in accordance with one embodiment of the present invention.

FIG. 12 illustrates an architecture for implementing a protocol stack in a multi-mode terminal, wherein an MIH CS exists as a function in accordance with one embodiment of the present invention.

FIG. 13 is a flowchart of a procedure for delivering commands and requests in accordance with one embodiment of the present invention.

FIG. 14 is a flowchart of a procedure for delivering commands and requests wherein an MIH CS is not included in accordance with one embodiment of the present invention.

FIG. 15 is a flowchart of a procedure for delivering requests wherein an MIH CS is included for facilitating communications between technology-specific interfaces (links) within a terminal in accordance with one embodiment of the present invention.

FIG. 16 is a flowchart of a procedure for initiating, initializing or resetting a terminal according to a protocol architecture in accordance with one embodiment of the present invention.

FIG. 17 is a flowchart of a deregistration procedure from an MIH CS in accordance with one embodiment of the present invention.

FIG. 18 is a flowchart of a link detection procedure in accordance with one embodiment of the present invention.

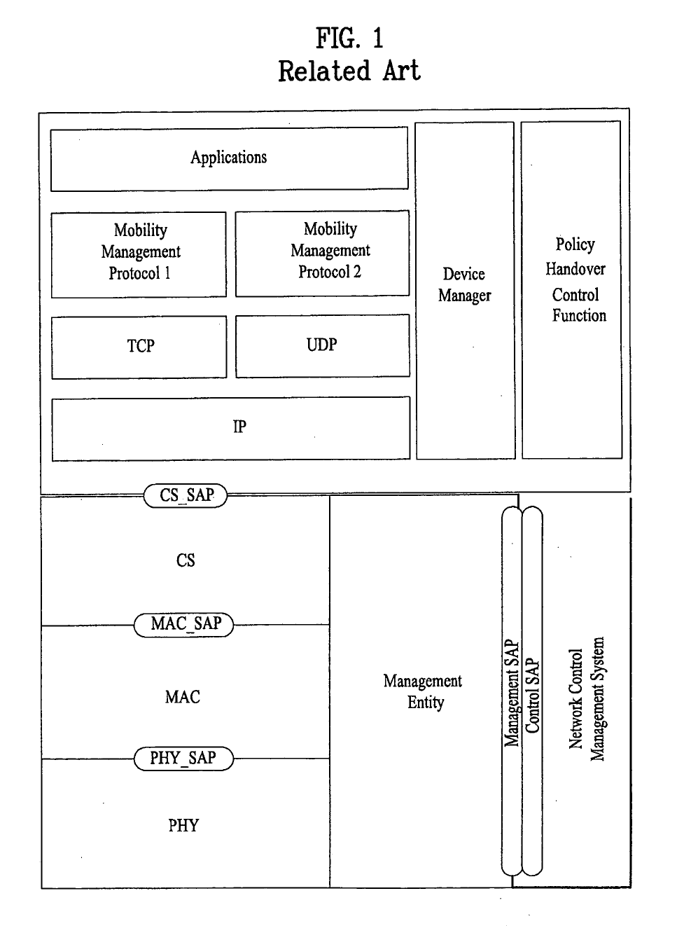

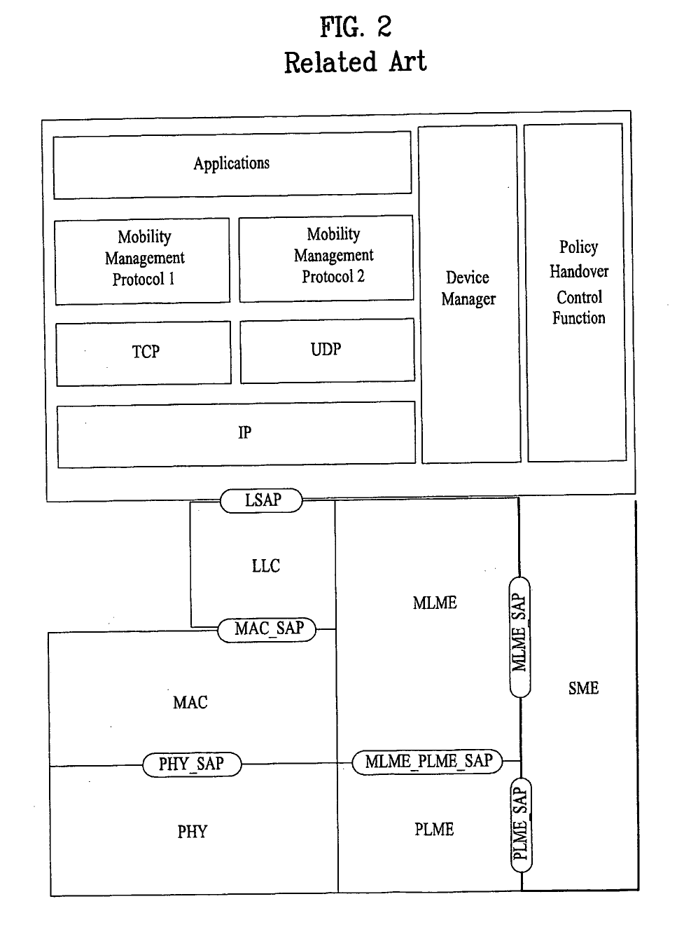

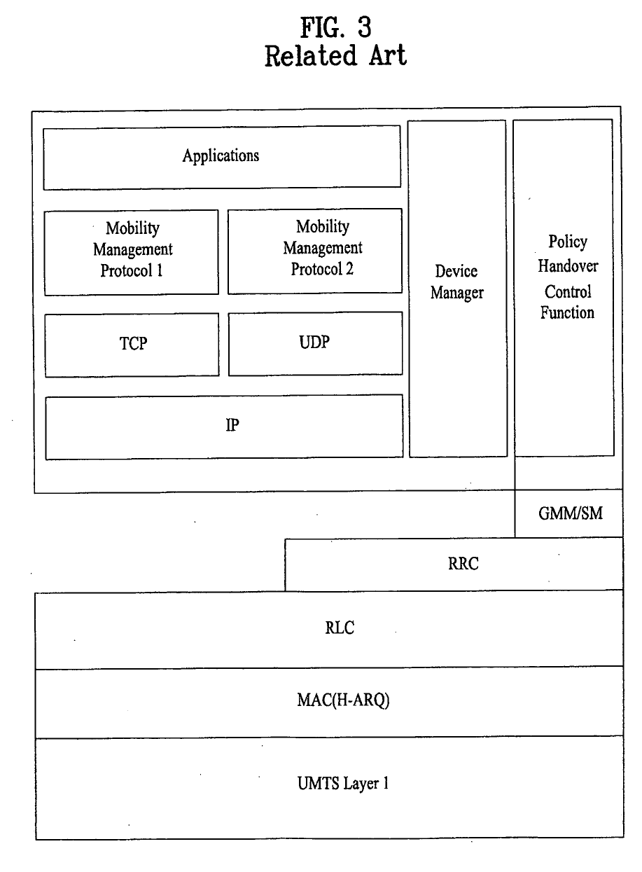

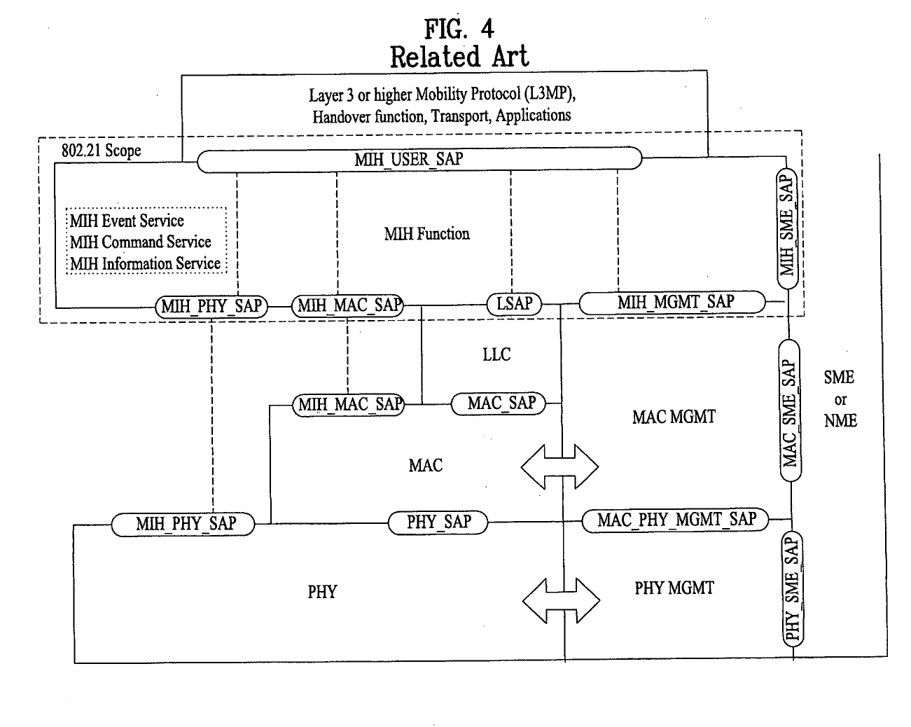

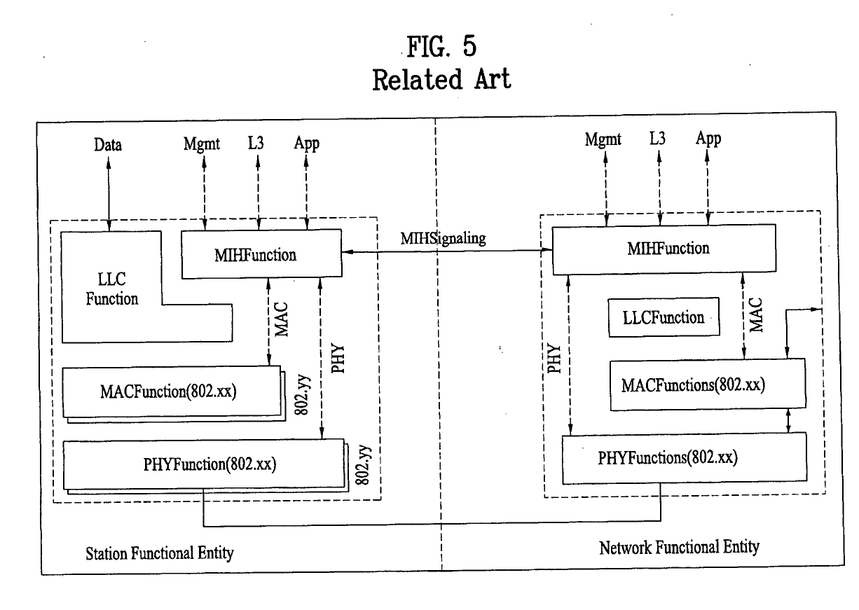

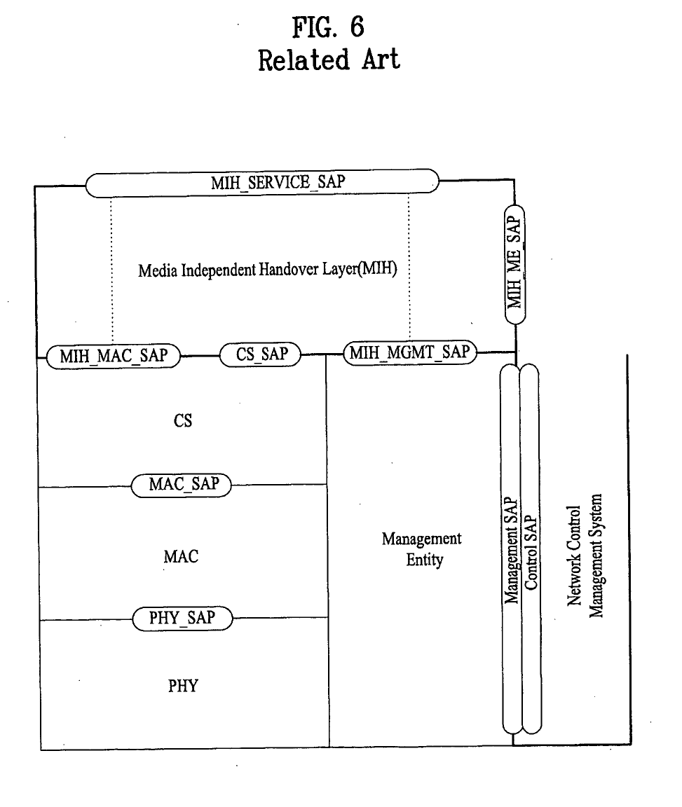

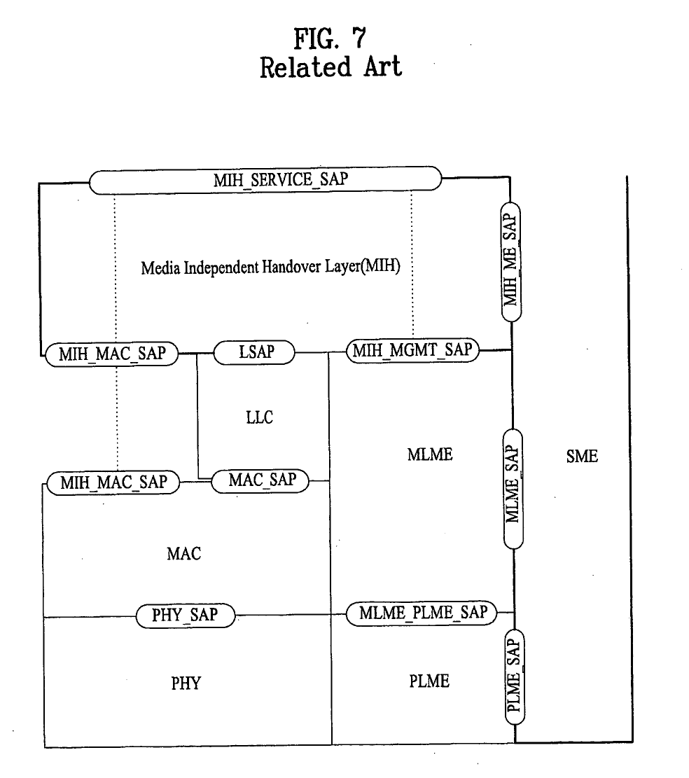

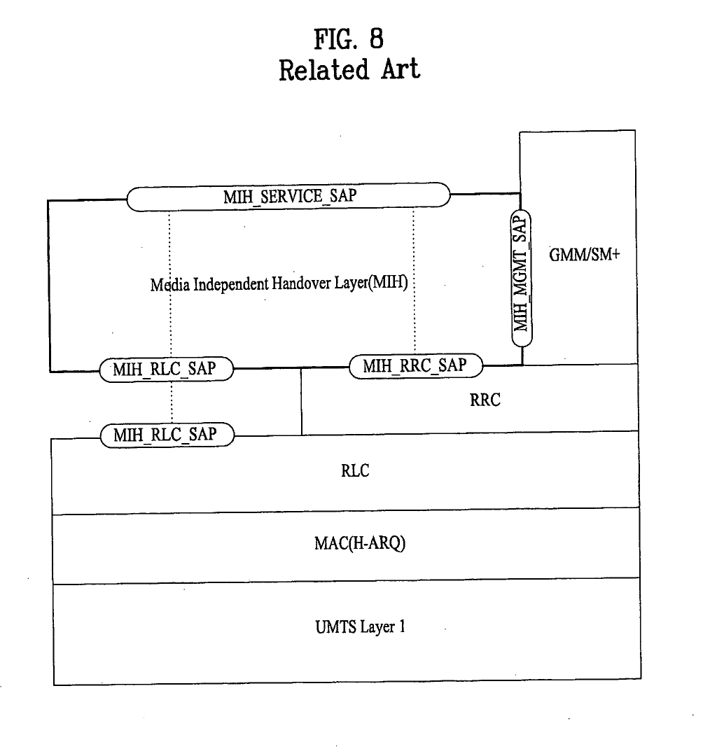

### DETAILED DESCRIPTION OF THE PREFERRED EMBODIMENTS

The present invention relates to a mobile terminal for performing media independent handover to at least one of a homogeneous and heterogeneous network in a broadband wireless access system.

Reference will now be made in detail to the preferred embodiments of the present invention, examples of which are illustrated in the accompanying drawings. Wherever possible, the same reference numbers will be used throughout the drawings to refer to the same or like parts.

The present invention defines a service access point (SAP) to support a media independent handover function (MIH). It may be classified by the existence or non-existence of an MIH convergence sublayer (MIH CS) according to message distribution and an MIH function range. The existence of the MIH CS can be additionally divided into an MIH lower convergence sublayer and an MIH higher convergence sublayer. The MIH CS is configured across all interface types of a multi-stack provided to a terminal. The MIH CS deals with policy enforcement, network selection, quality of service (QoS) parameter mapping, handover signaling and the like. Preferably, the object of the MIH CS is to act as a connection between a higher protocol and a lower MIH to facilitate equal application among different technologies regardless of the technologies' features dependent on media. Preferably, the technologies comprise at least one of a wired-line broadband system, a wireless broadband system and a cellular system. Preferably, the broadband system comprises at least one of a wireless local area network and a wireless metropolitan area network. Preferably, the cellular system comprises at least one of WCDMA and a cdma2000.

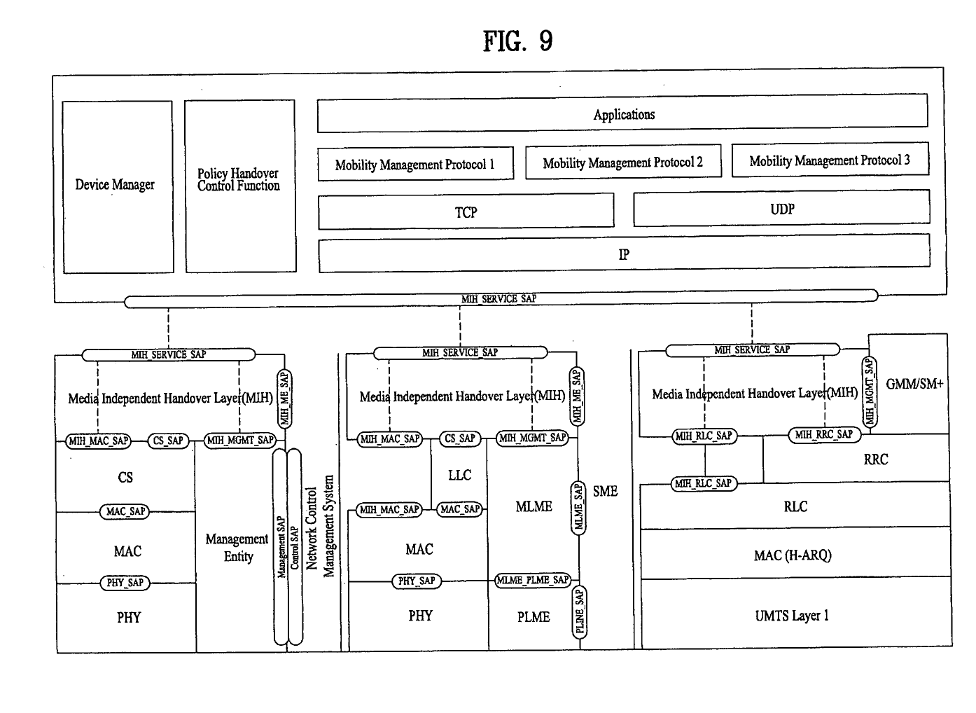

FIG. 9 illustrates an architecture for implementing a protocol stack in a multi-mode terminal, wherein an MIH CS is not included in accordance with one embodiment of the present invention. Referring to FIG. 9, because lower MIHs communicate with upper protocols, respectively, communications from the MIHs are preferably performed via the corresponding upper protocol or management entity.

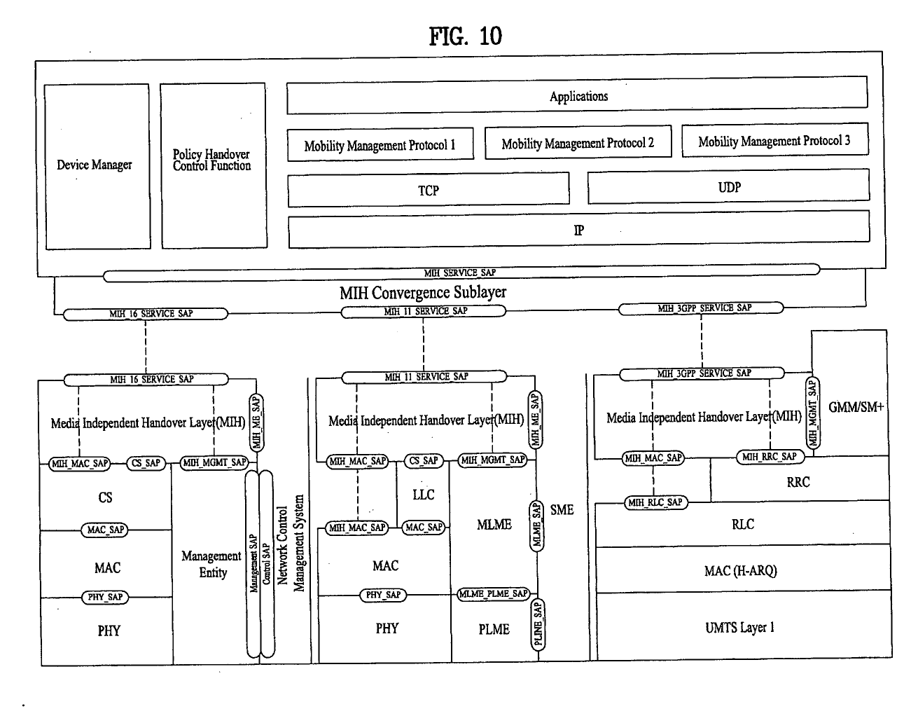

FIG. 10 illustrates an architecture for implementing a protocol stack in a multi-mode terminal, wherein an MIH CS is included in accordance with one embodiment of the present invention. Referring to FIG. 10, the MIH CS plays a role in managing lower MIHs. Signals delivered from the lower MIHs are collected by the MIH CS. The MIH CS then transfers the collected signal to higher layers. Notably, the MIH CS is capable of delivering lower layer signals to higher layers transparently. However, it is preferable that the MIH CS unify the signals from the lower MIHs by varying the lower layer signals and then deliver the unified signals to the higher layers.

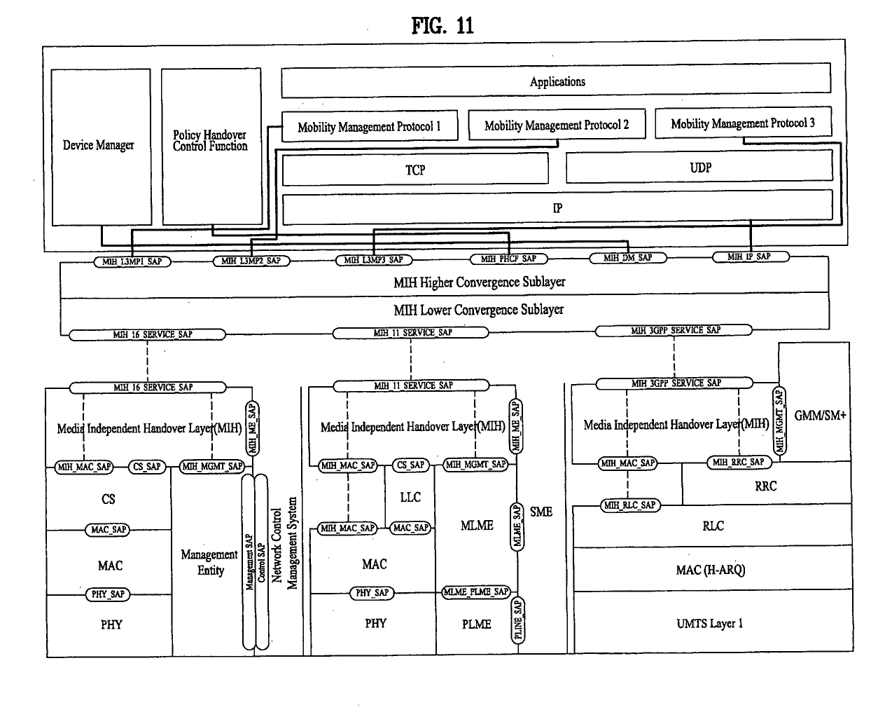

FIG. 11 illustrates an architecture for implementing a protocol stack in a multi-mode terminal, wherein an upper MIH CS and a lower MIH CS are included in accordance with one embodiment of the present invention. Referring to FIG. 11, an MIH is divided into an MIH Higher CS and an MIH Lower CS. Preferably, the MIH Lower CS functions similar to the MIH CS described in FIG. 10. Similarly, the MIH Higher CS takes charge of communications to and from higher protocols. If necessary, the MIH Higher CS establishes an individual SAP with each higher entity to individually communicate with the respective higher entity.

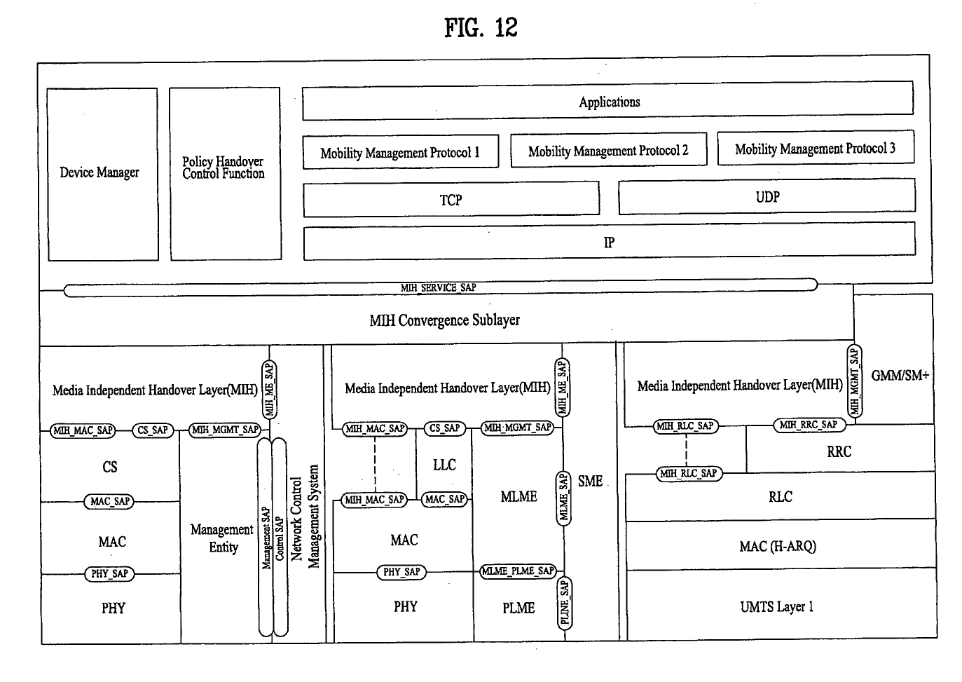

FIG. 12 illustrates an architecture for implementing a protocol stack in a multi-mode terminal, wherein an MIH CS exists as a function in accordance with one embodiment of the present invention. Referring to FIG. 12, an SAP between the MIH CS and the MIH need not exist.

Operational steps considering a protocol architecture in accordance with one embodiment of the present invention are classified as follows.

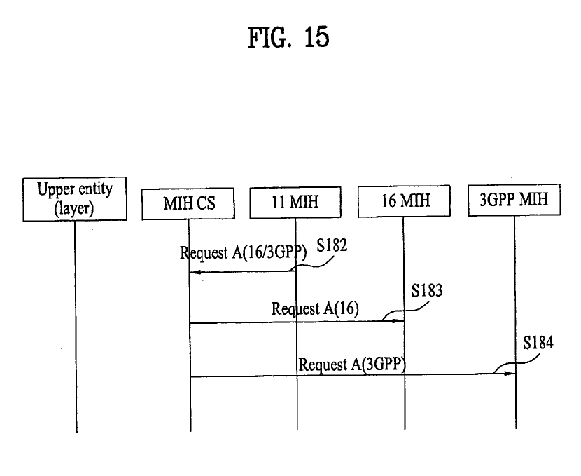

In an MIH Layer Registration Step, each lower MIH can be created during system operation. The MIH is registered to an MIH CS so that the MIH CS can discover the type of stack lying in a lower layer. A registration procedure, shown in FIG. 15, is then performed by an internal method since an SAP between the lower MIH and the MIH CS does not exist.

In a Registration-to-Management-Layer Step, the MIH CS learns of what types of stacks exist through the registration of the lower MIH. The MIH CS then registers the lower MIH to a management entity of a terminal. Preferably, the management entity is a separately existing entity. A function of the management entity may be replaced by the MIH. In case that the MIH functions as the management entity, the procedure registering the MIH to a management layer can be omitted.

In a Registration-to-MIH Step of Higher Layer Protocol Entity and Management Entity, once the MIH is operational, a higher protocol entity and a management entity register their requests to the MIH CS. The protocol entity and the management entity enabling the MIH to keep the requests help the MIH of a corresponding link reflect the requests by delivering the requests to the MIH of the corresponding link if the corresponding link is established. Registration of the higher protocol can be directly requested to the MIH by the higher protocol or can be performed via the management entity if the management entity separately exists. Higher protocols, as shown in FIG. 11, can communicate via existing SAPs. If higher protocols, as shown in FIG. 10, first initiate communications via the MIH_Service_SAP, higher SAPs, as shown in FIG. 11, can be created.

Furthermore, as shown in FIG. 12, an MIH function for each type of interface is constructed as part of its respective interface. However, in accordance with one aspect of the invention, the respective MIH functions of each interface may be integrated into the MIH CS.

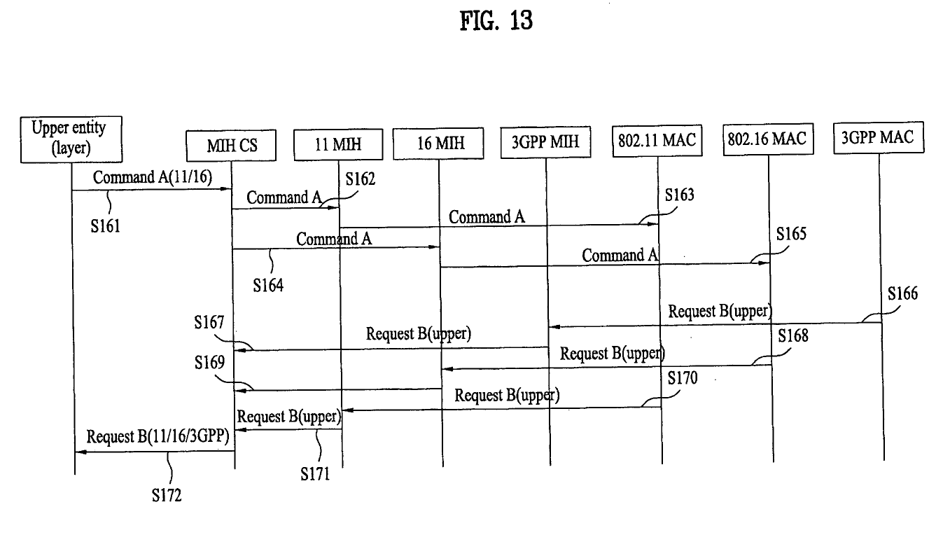

FIG. 13 is a flowchart of a procedure for delivering commands and requests in accordance with one embodiment of the present invention. Referring to FIG. 13, a higher layer delivers to the MIH CS a command to be delivered to a lower layer (S161). In the embodiment shown in FIG. 13, the higher layer sends a command to an IEEE 802.11 interface and an IEEE 802.16 interface.

The MIH CS handles the command received from the higher layer. If necessary, the MIH CS creates a new command or amends the received command and then delivers the command to a lower MIH layer (S162). In the embodiment shown in FIG. 13, the MIH CS delivers “Command A” to an IEEE 802.11 MIH.

Having received the command from the MIH CS, the IEEE 802.11 MIH communicates with a MAC layer using primitives defined in the protocols, respectively, if the MAC layer or lower layer needs to be processed (S163). In the embodiment shown in FIG. 13, the IEEE 802.11 MIH delivers the command to an IEEE 802.11 MAC. Notably, the command delivered to the IEEE 802.11 MAC is identified by “Command A”, which is identical to the command delivered to the IEEE 802.11 MIH, but may differ in delivery format and contents while having the same purpose.

If the MIH CS delivers “Command A” to the IEEE 802.16 MIH in a manner similar to that of the step S162 (S164), the 802.16 MIH delivers the “Command A” to the IEEE 802.16 MAC (S165). In this case, the command delivered to the IEEE 802.16 MAC is identified by “Command A”, which is identical to the command delivered to the IEEE 802.16 MIH, but may differ in delivery format and contents while having the same purpose.

The MAC layer or lower layer of each of the interfaces can transfer a request, an indicator and the like to the MIH layer according to a command given by a higher layer or a status change to be reported. In the embodiment shown in FIG. 13, the MAC layer of a 3GPP interface transfers a “Request B” to a 3GPP MIH for delivering the request to a higher layer (S166).

Having received from the 3GPP MAC layer the request to be delivered to the higher layer, the 3GPP MIH delivers the request to the MIH CS (S167). Preferably, the 3GPP MIH can deliver the request after having performed processing for MIH signaling. In the embodiment shown in FIG. 13, the 3GPP MIH delivers the “Request B” to the MIH CS.

Similar to the step S166, if the MAC layer of an IEEE 802.16 interface delivers a “Request B” to an IEEE 802.16 MIH for transferring to a higher layer (S168), the MIH of the IEEE 802.16 interface delivers the “Request B” to the MIH CS (S169). Likewise, if the MAC layer of an IEEE 802.11 interface delivers a “Request B” to an IEEE 802.11 MIH for transferring to a higher layer (S170), the MIH of the IEEE 802.11 interface delivers the “Request B” to the MIH CS (S171). Preferably, the request delivered to the MIH CS is identified by “Request B”, which is identical to the request delivered to the MIH in FIG. 13, but may differ in delivery format and contents while having the same purpose.

Preferably, the MIH CS gathers all information delivered from the lower layers and delivers them to corresponding entities (S172). In the embodiment shown in FIG. 13, the requests collected from the IEEE 802.11 interface, IEEE 802.16 interface and 3GPP interface are bound together for delivery to a higher layer.

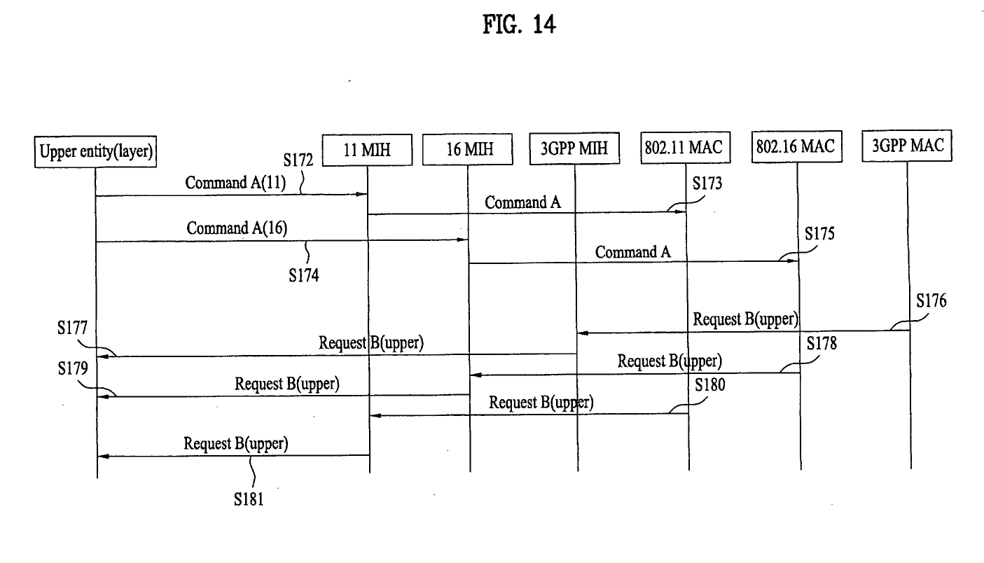

FIG. 14 is a flowchart of a procedure for delivering commands and requests wherein an MIH CS is not included in accordance with one embodiment of the present invention. Referring to FIG. 14, when a command to be delivered is generated, a higher layer individually gives a command to an MIH of a corresponding interface. In the embodiment shown in FIG. 14, a higher layer delivers commands to an IEEE 802.11 interface and an IEEE 802.16 interface, respectively.

When a command to be delivered to the IEEE 802.11 interface is generated, a higher layer gives the command to an IEEE 802.11 MIH (S172). Having received the command, the IEEE 802.11 MIH communicates with a MAC layer using primitives defined in the IEEE 802.11 interface if the MAC layer or lower needs to be processed. In the embodiment shown in FIG. 14, the IEEE 802.11 MIH delivers the command to an IEEE 802.11 MAC. The command delivered to the IEEE 802.11 MAC is identified by “Command A” in FIG. 14, which is identical to the command delivered to the IEEE 802.11 MIH, but may differ in delivery format and contents while having the same purpose.

If a higher entity delivers a “Command A” to an IEEE 802.16 MIH (S174), the IEEE 802.16 MIH delivers the “CommandA” to an IEEE 802.16 MAC (S175). In this case, the command delivered to the IEEE 802.16 MAC is identified by “Command A” in FIG. 14, which is identical to the command delivered to the IEEE 802.16 MIH, but may differ in delivery format and contents while having the same purpose.

The MAC layer or lower layer of each of the interfaces can transfer a request to a higher layer, an indicator and the like to a corresponding MIH layer according to a command given by a higher layer or a status change to be reported. When the MIH layer receives from the MAC layer of a corresponding interface the request to be delivered to the higher layer, the MIH delivers the request to a corresponding higher entity. Preferably, the MIH of the corresponding interface can deliver the request after having performed processing for MIH signaling.

If a MAC layer of a 3GPP interface transfers a “Request B” to a 3GPP MIH for delivery to a higher layer (S176), the 3GPP MIH delivers the “Request B” to the corresponding higher layer (S177). In this case, the delivered request is identified by “Request B” in FIG. 14, which is identical to the request delivered to the 3GPP MIH, but may differ in delivery format and contents while having the same purpose.

If a MAC layer of an IEEE 802.16 interface delivers a “Request B” to an IEEE 802.16 MIH for transferring to a higher layer (S178), the IEEE 802.16 MIH delivers the “Request B” to a higher entity (S179). Likewise, if a MAC layer of an IEEE 802.11 interface delivers a “Request B” to an IEEE 802.11 MIH for transferring to a higher layer (S180), the IEEE 802.11 MIH delivers the “Request B” to a higher entity (S181). In this case, the request delivered to the higher entity is identified by “Request B” in FIG. 14, which is identical to the request delivered to the MIH, but may differ in delivery format and contents while having the same purpose.

FIG. 15 is a flowchart of a procedure for delivering requests wherein an MIH CS is included for facilitating communications between technology-specific interfaces (links) within a terminal in accordance with one embodiment of the present invention.

Referring to FIG. 15, if an MIH governing an IEEE 802.11 link attempts to communicate with an MIH governing an IEEE 802.16 link or 3GPP link, the IEEE 802.16 MIH transfers a message to an MIH CS (S182). The MIH CS, which is connected to MIHs of all links in common, can then transfer the received message to the MIH of the corresponding link (S183, S184). In the embodiment shown in FIG. 15, the message is transparently delivered to another entity. Substantially, the MIH CS can transparently deliver the message. Optionally, the message is processed by a function of the MIH CS prior to delivery or a different message attributed to the former message is created and then delivered.

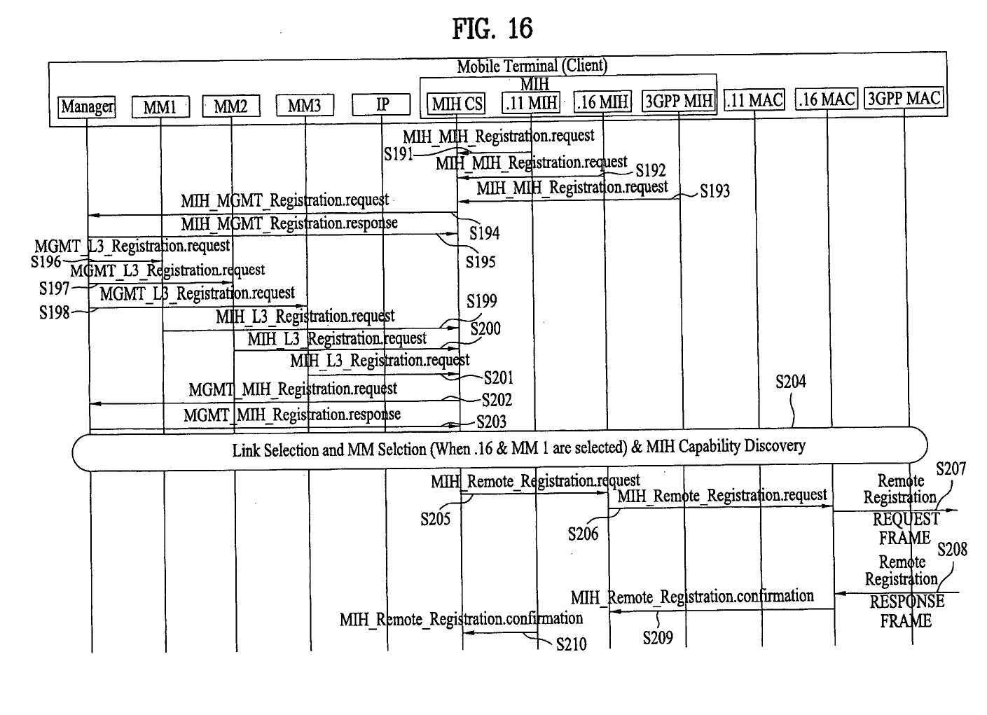

FIG. 16 is a flowchart of a procedure for initiating, initializing or resetting a terminal according to a protocol architecture in accordance with one embodiment of the present invention. Referring to FIG. 16, MIHs capable of communicating with respective links (interfaces) register their existences to an MIH CS in initial drive. In the embodiment shown in FIG. 16, registration is made via an MIH_MIH_Registration.request. Accordingly, an MIH_MIH_Registration.response may be transferred to the MIH of a corresponding link from the MIH CS. It is also possible to notify success or failure of the registration from the MIH CS. In FIG. 16, an IEEE 802.11 MIH is registered to the MIH CS (S191). Likewise, an IEEE 802.16 MIH and a 3GPP MIH are registered to the MIH CS (S192, S193).

Based on the registration result of the MIHs of the interfaces, the MIH CS registers the MIHs' status/capabilities to a management entity (S194). Preferably, the management entity comprises a device manager, a handover manager and the like. In the event that the management entity is divided, each management entity should execute a separate registration procedure.

The management entity generates a response to the registration result and delivers it to the MIH CS (S195). In doing so, insupportable functions are enumerated and delivered as a result of negotiation for status/capabilities. In the embodiment shown in FIG. 16, registration is made via an MIH_L3_Registration.request to the MIH CS. Accordingly, an MIH_L3_Registration.response may be transferred to the MIH of a corresponding link from the MIH CS. It is also possible to notify success or failure of the registration from the MIH CS.

Preferably, the management entity first loads the requests on mobility management (MM) entities MM1, MM2 and MM3 and orders them to register with the MIH CS, respectively (S196, S197, S198). The MM entities ordered by the management entity are then registered to the MIH CS with their requests (S199, S200, S201). In doing so, information expected to be received in the future by the MM entities, such as event services (triggers) necessary for mobility management, are enumerated and registered in the MIH CS.

Furthermore, the management entity registers itself to the MIH CS with its requests as well (S202, S203). Through this, information expected to be received in the future from the MIH (including the MIH CS) by the management entity, such as event services (triggers) necessary for mobility management are enumerated and registered in the MIH CS. The MIH CS then notifies the management entity of the result of the registration. Accordingly, registration failure or success and supportability of the registered services may be indicated.

If a link (interface) to be accessed is selected and if a mobility management (MM) entity is decided (S204), the MIH CS enumerates and registers information to be transferred by the MIH of the corresponding link (interface) based on the registration contents received by the MIH CS from the MM entity (S205). FIG. 16 shows an example where the MIH CS asks a registration of an IEEE 802.16 MIH if the IEEE 802.16 interface is selected.

If information, to be remotely received for handover between heterogeneous networks due to a remote registration made by the MIH of the corresponding link, e.g. event services, is requested, this request is registered to a base station or MIH in a network (S206). In making this registration, a method via L2 or a method via L3 or higher is used. The method via L2 is classified into a method via a control plane using a MAC management message and a method of transfer to L2 by defining a new Ethertype for reception by the MIH. In the embodiment shown in FIG. 16, the MIH triggers the MAC using a primitive so that the MAC transfers a MAC management message.

An IEEE 802.16 MAC transmits a remote registration request frame (MAC management message) via air interface (S207). A base station having received the remote registration request frame performs processing necessary for the registration and then transmits a response frame responding to the remote registration request (S208).

The MAC layer receives the response frame from the base station and then reports it to the MIH layer via a primitive (S209). The MIH of the corresponding link reports the primitive to the MIH CS so that the MIH CS can perform management by a unified method.

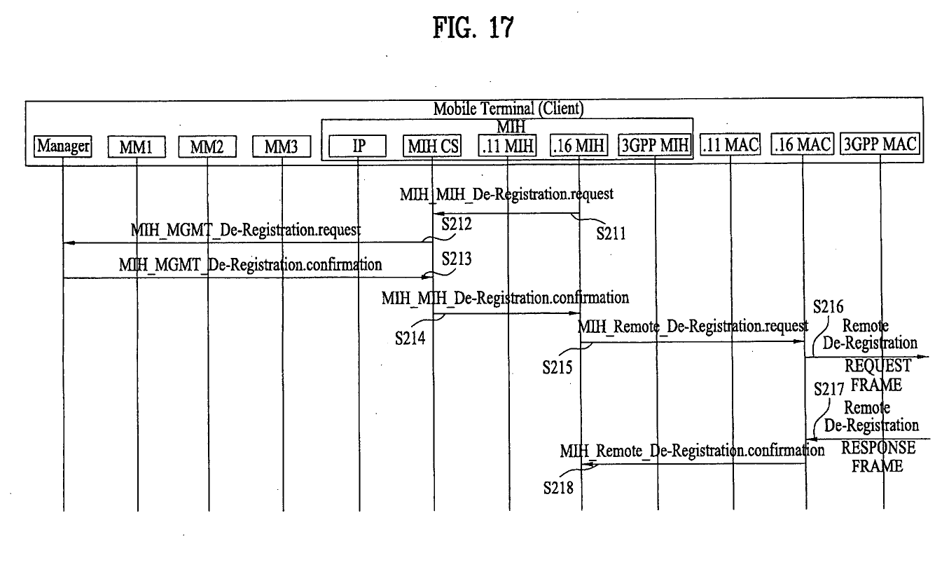

FIG. 17 is a flowchart of a deregistration procedure from an MIH CS in accordance with one embodiment of the present invention. The deregistration procedure may be utilized when an MIH of each link (interface) wishes to deregister due to a link change or the like. As shown, FIG. 17 describes a deregistration procedure for an IEEE 802.16 interface only; however, the deregistration procedure is applicable to other interfaces as well.

Referring to FIG. 17, an IEEE 802.16 MIH transfers a primitive for deregistration to an MIH CS (S211). The MIH CS then notifies the deregistration to a management entity (S212). In the embodiment shown in FIG. 17, a management entity is separately provided; however, if a management entity function is implemented by the MIH CS, step S212 may be omitted.

The management entity generates a response to the deregistration request and transfers it to the MIH CS (S213). The MIH CS then notifies the corresponding link, i.e., the IEEE 802.16 MIH, that the deregistration procedure is completed (S214).

The IEEE 802.16 MIH requests a primitive from an IEEE 802.16 MAC (S215), wherein the primitive requests deregistration for releasing a previously-registered remote registration. Like the embodiment shown in FIG. 16, the remote deregistration method is classified into a method via L2 or a method via L3 or higher. The method via L2 is classified into a method via a control plane using a MAC management message and a method of transfer to L2 by defining a new Ethertype for reception by the MIH. In the embodiment shown in FIG. 17, the MIH triggers the MAC using a primitive so that the MAC transfers the MAC management message.

The IEEE 802.16 MAC transmits a remote deregistration request message (MAC management message) via an air interface (S216). A base station having received the remote deregistration request frame then performs processing necessary for the deregistration and transmits a response frame responding to the remote deregistration request to the IEEE 802.16 MAC (S217). The IEEE 802.16 MAC layer receives the response frame from the base station and then notifies a higher MIH via a primitive that the remote deregistration request response was received (S218).

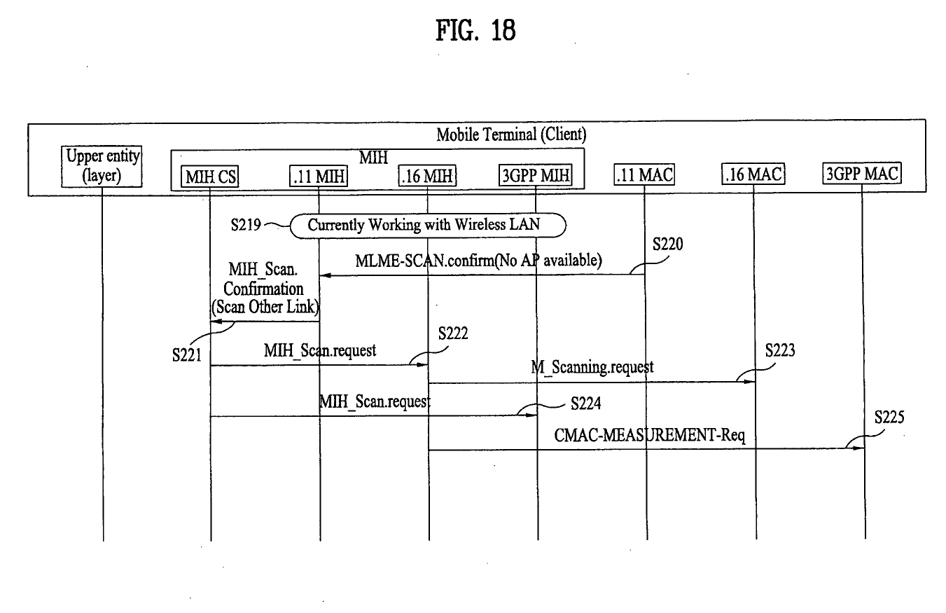

FIG. 18 is a flowchart of a link detection procedure in accordance with one embodiment of the present invention. In FIG. 18, an MIH CS is included to perform communications between technology-specific interfaces (links) within a terminal. Referring to FIG. 18, a multi-mode mobile terminal operating via a wireless LAN notifies an MIH governing an IEEE 802.11 interface that a currently operating MAC layer fails to discover an available access point (AP) or point of attachment (POA) in a periodic or requested scanning. The MIH is notified by inserting a parameter, indicating no more available AP or POA, into an MLME-SCAN.confirm primitive (S220). An MIH governing the IEEE 802.11 link requests the MIH CS to scan another link via an MIH_Scan.confirmation (S221). The MIH CS then decides that another link detection is needed and transfers a scan request for another link detection to the MIH governing the corresponding link. An MIH_Scan.request is transmitted to an IEEE 802.16 MIH and a 3GPP MIH to request a scanning. The MIH_Scan.request is also transmitted to the IEEE 802.11 MIH since it has received the notification indicating that there is no available access point or point of attachment (S222, S224). The IEEE 802.16 MIH and the 3GPP MIH request corresponding MAC layers to detect links via an “IEEE 802.16 primitive and M_Scanning.request” and a “3GPP primitive and CMAC-MEASUREMENT-Req”, respectively (S223, S225).

Accordingly, the present invention proposes the relations between the terminal for handover between media-independent heterogeneous networks and the respective entities. In particular, by providing an MIH for communications with an IP layer or higher and an MIH for each multi-link, handover in a multi-mode terminal is efficiently and systematically managed via an MIH convergence sublayer (CS) managing the MIHs. Hence, a processing delay occurring in inter-heterogeneous-network media independent handover can be reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

The forgoing embodiments and advantages are merely exemplary and are not to be construed as the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents by also equivalents structures.

What is claimed is:

1. A mobile terminal for performing a handover to at least one of a homogeneous and heterogeneous network, the mobile terminal comprising:
at least one network interface module supporting a predetermined air interface;
a heterogeneous network handover module configured to provide convergence of information from the at least one network interface module associated with the at least one of a homogeneous and heterogeneous network into a unified presentation; and
a management module configured to process the unified presentation communicated with the heterogeneous network handover module to communicate with the at least one network interface module to facilitate handover.

2. The mobile terminal of claim 1, wherein the heterogeneous network handover module comprises at least one media independent handover entity corresponding to the at least one network interface module.

3. The mobile terminal of claim 1, wherein the heterogeneous network handover module comprises a heterogeneous network handover submodule configured to provide convergence of information and at least one media independent handover entity corresponding to the at least one network interface module.

4. The mobile terminal of claim 1, wherein the heterogeneous network handover module comprises a first heterogeneous network handover module configured to communicate with the management module and a second heterogeneous network handover module configured to communicate between the first heterogeneous network handover module and the at least one network interface module.

5. The mobile terminal of claim 1, wherein the at least one network interface module comprises one of a wired-line broadband interface, a wireless broadband interface and a cellular interface.

6. The mobile terminal of claim 5, wherein the broadband interface comprises at least one of a wireless local area network and a wireless metropolitan area network.

7. The mobile terminal of claim 5, wherein the cellular interface comprises at least one of a WCDMA and a cdma2000.

8. The mobile terminal of claim 1, wherein the management module comprises at least one of a device manager, a mobility management protocol, an Internet protocol module, a transmission control protocol module and a user datagram protocol module.

9. The mobile terminal of claim 1, wherein the unified presentation of the heterogeneous network handover module is communicated to the management module through a service access point.

10. The mobile terminal of claim 1, wherein the heterogeneous network handover module communicates with the at least one network interface module through a management service access point and a control service access point.

11. The mobile terminal of claim 1, wherein the heterogeneous network handover module communicates with the at least one network interface module through one of a MAC sublayer management entity and a physical layer management entity.

12. A method for performing handover to at least one of a homogeneous and heterogeneous network, the method comprising:
supporting a predetermined air interface with at least one network interface module;
providing a heterogeneous network handover module for converging information from the at least one network interface module associated with the at least one of a homogeneous and heterogeneous network into a unified presentation; and
providing a management module for processing the unified presentation communicated with the heterogeneous network handover module to communicate with the at least one network interface module to facilitate handover.

13. The method of claim 12, wherein the heterogeneous network handover module comprises at least one media independent handover entity corresponding to the at least one network interface module.

14. The method of claim 12, wherein the heterogeneous network handover module comprises a heterogeneous network handover submodule configured to provide convergence of information and at least one media independent handover entity corresponding to the at least one network interface module.

15. The method of claim 12, wherein the heterogeneous network handover module comprises a first heterogeneous network handover module configured to communicate with the management module and a second heterogeneous network handover module configured to communicate between the first heterogeneous network handover module and the at least one network interface module.

16. The method of claim 12, wherein the at least one network interface module comprises one of a wired-line broadband interface, a wireless broadband interface and a cellular interface.

17. The method of claim 16, wherein the broadband interface comprises at least one of a wireless local area network and a wireless metropolitan area network.

18. The method of claim 16, wherein the cellular interface comprises at least one of a WCDMA and a cdma2000.

19. The method of claim 12, wherein the management module comprises at least one of a device manager, a mobility management protocol, an Internet protocol module, a transmission control protocol module and a user datagram protocol module.

20. The method of claim 12, wherein the unified presentation of the heterogeneous network handover module is communicated to the management module through a service access point.

21. The method of claim 12, wherein the heterogeneous network handover module communicates with the at least one network interface module through a management service access point and a control service access point.

22. The method of claim 12, wherein the heterogeneous network handover module communicates with the at least one network interface module through one of a MAC sublayer management entity and a physical layer management entity.
